(19) United States
(12) Patent Application Publication
(10) Pub. No.: US 2008/0033326 A1
(43) Pub. Date: Feb. 7, 2008

(54) Mattress pad having vibrational and temperature control capabilities

(76) Inventor: Diane Evans, Raleigh, NC (US)

Correspondence Address: Raymond M. Galasso;Galasso & Associates LP, P.O. Box 26503, Austin, TX, 78755-0503, US

(21) Appl. No.: 11/827,471

(22) Filed: Jul. 12, 2007

Related U.S. Application Data
(60) Provisional application No. 60/830,451, filed on Jul. 13, 2006.

(51) Int. Cl. A61H 23/00; A47C 21/00

(52) U.S. Cl. 601/15; 5/498; 601/57; 607/96

(57) ABSTRACT

A therapeutic mattress pad configured to provide a plurality of stimulus to a user in order to treat muscle pain. The therapeutic mattress pad further includes a body that comprises a first layer and a second layer. Disposed intermediate the first layer and the second layer of the body is at least one heating element to provide a temperature stimulus to the user. Further, at least one vibrating device is disposed intermediate the first layer and second layer of the body and is configured to provide a vibrating stimulus to the user. A controller is operably connected to the heating element and the vibrating device so as to provide an interface for the user to control the stimulus provided.

### PRIORITY UNDER 35 U.S.C. 119(e) & 37 C.F.R. 1.78

This nonprovisional application claims priority based upon the following prior U.S. provisional patent application entitled: Heated massaging mattress pad, Application No.: 60/830,451, filed Jul. 13, 2006, in the name of Diane Evans, which is hereby incorporated by reference for all purposes.

### FIELD OF THE INVENTION

The present invention relates to a therapeutic device, more specifically but not by way of limitation, a mattress pad that provides stimulation to an adjacent user's muscle by utilizing vibration as well as has the ability to maintain a temperature dissimilar to that of its surroundings.

### BACKGROUND

Millions of individuals suffer from a variety of general muscular maladies such as lower back pain. Back pain and shoulder pain are the two most common types of chronic pain in the United States. Individuals that suffer from these maladies often subsequently suffer from sleep disorders as the pain hinders the patient's ability to achieve the recommended amount of sleep.

Millions of patients each year ingest prescribed medications in an effort to provide relief from the chronic pain as well as to assist with a more consistent sleep pattern. These prescription medications can have dangerous side effects including the most severe of addiction. Additionally, millions of individuals purchase a variety of different types of mattresses ranging from memory foam mattresses to inner spring mattresses in an effort to control the pain as an alternative to utilizing medication. One issue with existing mattresses is that they are unable to provide temperature control dissimilar to that of its environment. Temperature, such as but not limited to heat, is often used to sooth chronic back and shoulder pain.

Another treatment of chronic muscular pain is massage. Massaging the muscular areas afflicted with pain temporarily relaxes the muscle fibers providing relief from the pain. Inner spring mattresses and memory foam mattresses are unable to provide massage-like vibrational therapy in an attempt to relieve muscular pain.

Accordingly, there is a need for a device that can be placed adjacent to a surface such as a mattress that can provide relief to a user from muscular pain through utilization either isolated or in combination vibrational therapy or temperature therapy.

### SUMMARY OF THE INVENTION

It is the object of the present invention to provide a therapeutic device to relieve pain such as but not limited to muscular pain which can be releasably secured to a commercially available mattress.

It is a further object of the present invention to provide a therapeutic device for pain management that uses vibration therapy to provide relief of muscular pain.

Another object of the present invention is to provide a therapeutic device for pain management that has the ability to maintain a temperature dissimiliar to that of its environment to provide relief from muscular pain.

Yet another object of the present invention is to provide a therapeutic device for pain management that is manufactured in a plurality of sizes.

A further object of the present invention is to provide a therapeutic device for pain management that is moisture resistant.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a perspective view of an embodiment of the present invention;

FIG. 2 illustrates an enlarged detailed view of a control unit utilized in the present invention; and

FIG. 3 illustrates a detailed partial sectional view of the body of the present invention.

### DETAILED DESCRIPTION

Referring now to the drawings submitted herewith, wherein various elements depicted are not necessarily drawn to scale and wherein throughout the Figures like elements are identified with like reference numerals there is illustrated a therapeutic device 100 constructed according to the principles of the present invention.

The therapeutic device 100 comprises a body 10 configured in a substantially planar manner. The body 10 is operably coupled to a power cord 30 which is configured to provide power to the therapeutic device 100. A controller 35 is operably connected to the power cord 30 and is configured to regulate the operation and functionality of the therapeutic device 100.

The body 10 is constructed of suitable durable materials such as but not limited to cotton or polyester. The body 10 further comprises a first layer 20 and a second layer 15. The first layer 20 and the second layer 15 are secured to each other utilizing suitable and durable methods such as but not limited to stitching or chemical adhesion. The body 10 is configured in a substantially planar manner and is generally rectangular in shape. The size and shape of the body 10 allows it to be superposed on a conventional mattress and provide a large surface area for the user, as well as help protect the mattress from moisture. It is contemplated within the scope of the present invention that the body 10 be manufactured approximately in the size and shape of conventional bed sizes such as but not limited to twin, full, queen and king size mattresses.

While it is contemplated within the scope of the present invention that the body 10 is rectangular in shape so as to be superposed to a conventional mattress, it is further contemplated that the body 10 could be manufactured in numerous different shapes and sizes so as be superposed to a plurality of objects such as but not limited to a chair. It should also be recognized by those skilled in the art that the body 10 could be manufactured in numerous different colors.

Referring in particular to FIG. 3, a plurality of heating elements 310 are intermediate the first layer 20 and the second layer 15 of the body 10. The heating elements 310 generally function to allow a user to raise the temperature of the therapeutic device 100 to a temperature higher than that of its surroundings. The heating elements 310 are operably connected to the power cord 30 which supplies the necessary voltage to operate the heating elements 310. The heating elements 310 are constructed of materials that have a high resistivity thereby having the ability to produce sufficient heat. The heating elements 310 are manufactured from materials such as but not limited to nickel and chromium alloy wrapped in a protective casing. It is further contemplated within the scope of the invention, that in place of and/or in conjunction with the heating elements 310, the body 10 could have disposed therein a method to lower the temperature of the body 10 as compared to that of its surroundings. It should also be recognized that the heating element 310 could be a single continuous element or a plurality of operably connected heating elements 310.

A stimulation layer 320 is adjacent and superposed to the first layer 20 and is secured thereto by suitable and durable mechanical or chemical methods. The stimulation layer 320 is operably connected to the power cord and functions to stimulate the muscles of a user that is superposed on the therapeutic device 100. It is contemplated within the scope of the present invention that the stimulation layer 320 could utilize one or more electric motors with an offset weight to produce vibrations that would be transferred to the user superposed on the therapeutic device 100. It should be recognized by those skilled in the art that a single speed or variable speed vibrating motors could be used to generate the vibrations for the stimulation layer 320. The stimulation layer 320 is manufactured of suitable durable materials and is constructed so as to generally distribute the vibrations produced by the vibrating motors.

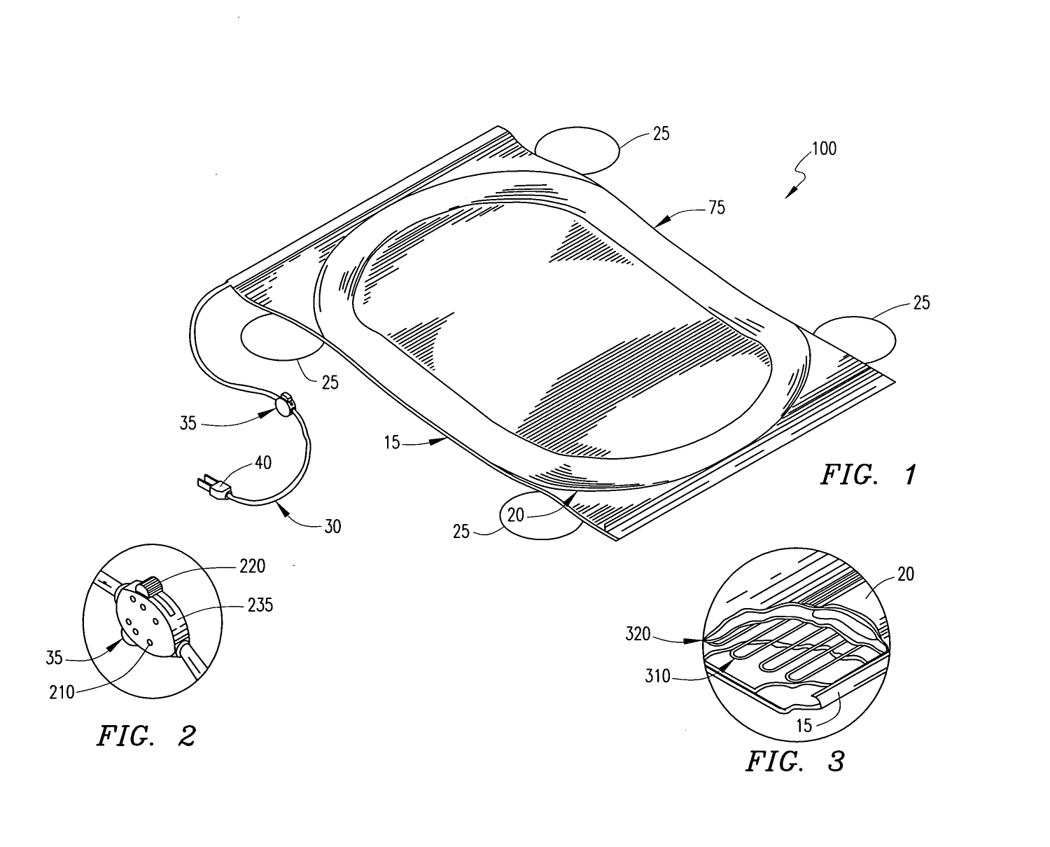

As shown in FIG. 1, the power cord 30 is operably connected to the heating element 310 and the stimulation layer 320 of the therapeutic device 100. The power cord 30 is constructed to operate with conventional 110 or 220 volts.

Referring in particular to FIG. 2, controller 35 is operably configured to the power cord 30. The controller 35 functions to regulate the power transmitted to the therapeutic device 100 thereby controlling each of the temperature of the heating elements 310 and the amount of vibration in the stimulation layer 320. The controller 35 has a housing 235 that is manufactured of a suitable durable material such as but not limited to plastic. The controller 35 has integrally mounted thereon a switch 220 and a plurality of buttons 210. The switch 220 is a conventional electric switch that functions to regulate the temperature of the heating elements 310 through control of the current transmitted to the heating elements. The buttons 210 function to control the stimulation layer 320 of the therapeutic device 100 by regulating the current to produce a desired amount of vibrations to the user. The controller 35 functions to operate the heating elements 310 and the stimulation layer 320 either independently or in simultaneous modes.

A pair of attachment mechanisms 25 are secured proximate the longitudinal ends 75 of the body 10. The attachment mechanisms 25 are secured to the body 10 using suitable durable methods such as but not limited to stitching. The attachment mechanisms 25 function to releasably secure the therapeutic device 100 to a mattress. The attachment mechanisms 25 are constructed of a durable and expandable material such as but not limited to elastic.

Referring in particular to FIG. 1, a description of the operation of the therapeutic device 100 is as follows. In use, a user will superpose the therapeutic device 100 adjacent to a desired surface such as a mattress. Using the attachment mechanisms 25, the user will releasably secure the therapeutic device 100 to the desired surface. The power cord 30 will be engaged to the appropriate power source via the plug 40 in order to supply the necessary power to operate the therapeutic device 100. A user will then lay on the therapeutic device 100, and use the controller 35 to adjust the temperature and control the vibration of the therapeutic device 100 for the desired length of time.

In the preceding detailed description, reference has been made to the accompanying drawing that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A therapeutic device for assisting a user in treating muscle pain comprising:
a body, said body being generally rectangular in shape and configured in a substantially planar manner, said body being operable in a first mode and a second mode in order to provide at least one stimulus for each of said first mode and said second mode to the user; and
wherein each of said at least one stimulus is controlled by the user.

2. The therapeutic device as recited in claim 1, and further including a controller, said controller being operable to provide the user an interface to control the operation of each of said at least one stimulus.

3. The therapeutic device as recited in claim 2, wherein said first mode operates to provide to provide a temperature stimulus.

4. The therapeutic device as recited in claim 3, wherein said second mode operates to provide a vibrating stimulus.

5. The therapeutic device as recited in claim 4, and further including an attachment mechanism operable to releasably secure said body to a mattress.

6. The therapeutic device as recited in claim 5, and further including a power cord connected to said body, said power cord operable to deliver power to said body from a power source.

7. A therapeutic device for assisting a user in treating muscle pain that is configured to be placed adjacent to a mattress comprising:
a body, said body having a first layer and a second layer, said body being generally rectangular in shape; and
said body operable to provide a plurality of stimuli to a user.

8. The therapeutic device as recited in claim 7, and further including at least one heating element, said at least one heating element positioned intermediate said first layer and said second layer of said body, said at least one heating element operable to provide heat stimulus to the user.

9. The therapeutic device as recited in claim 8, and further including at least one vibrating device, said at least one vibrating device positioned intermediate said first layer and said second layer, said vibrating device being operable to provide a vibration stimulus to the user.

10. The therapeutic device as recited in claim 9, and further including a controller, said controller being connected to said body, said controller operable to activate each of said at least one heating element and said at least one vibrating device.

11. The therapeutic device as recited in claim 10, wherein said controller being operable in a first mode, such that said controller activates said at least one heating element.

12. The therapeutic device as recited in claim 11, wherein said controller being operable in a second mode, such that said controller activates said at least one vibrating device.

13. The therapeutic device as recited in claim 12, wherein said controller being operable in a third mode, such that said controller activates each of said at least one heating element and said at least one vibrating device.

14. A therapeutic mattress pad configured to be releasably secured to a conventional mattress operable to assist a user in treating muscle pain by providing a plurality of stimulus comprising:
a body, said body having a first layer and a second layer, said body being generally rectangular in shape,
at least one heating element, said heating element being intermediate said first layer and said second layer of said body, said heating element configured to provide a temperature stimulus to the user;
at least one vibrating device, said vibrating device being intermediate said first layer and said second layer, said vibrating device operable to provide a vibrating stimulus to the user; and
a controller, said controller operably connected to said at least one heating element and to said at least one vibrating device, said controller being operable in a first mode, a second mode, and a third mode.

15. The therapeutic mattress pad as recited in claim 14, wherein said controller being operable in said first mode, said controller provides power to said at least one heating element so as to provide a temperature stimulus to the user.

16. The therapeutic mattress pad as recited in claim 15, wherein said controller being operable in said second mode, said controller provides power to said at least one vibrating device so as to provide a vibration stimulus to the user.

17. The therapeutic mattress pad as recited in claim 16, wherein said controller being operable in said third mode, said controller provides power to said at least one heating element and said at least one vibrating device simultaneously in order to provide a temperature stimulus and a vibrating stimulus to the user.

18. The therapeutic mattress pad as recited in claim 17, wherein said first layer and said second layer of said body is manufactured to be moisture resistant to protect said at least one heating element and said at least one vibrating device.

19. The therapeutic mattress pad as recited in claim 18, and further including at least one attachment mechanism, said attachment mechanism for releasably securing said therapeutic mattress pad to a conventional mattress.

20. The therapeutic mattress pad as recited in claim 19, wherein said therapeutic mattress pad is configured to operably connect to a standard 120 volt power source.
